(19) United States
(12) Patent Application Publication
(10) Pub. No.: US 2008/0274844 A1
(43) Pub. Date: Nov. 6, 2008

(54) False activation reducing centrifugal activation system

(75) Inventor: Thomas Alan Ward, Eugene, OR (US)

Correspondence Address: SILVERSKY GROUP LLC, 5422 LONGLEY LANE , SUITE B, RENO, NV, 89511, US

(73) Assignee: EMD3, Reno, NV (US)

(21) Appl. No.: 12/148,854

(22) Filed: Apr. 22, 2008

Related U.S. Application Data
(60) Provisional application No. 60/927,569, filed on May 3, 2007.

(51) Int. Cl. A63B 43/06; H01H 35/10; A63H 5/00; A63H 33/26

(52) U.S. Cl. 473/570; 200/80 R; 446/397; 446/485

(57) ABSTRACT

The present invention is directed to a false activation reducing centrifugal activation system. The system is an activation system that may be used to activate a wide variety of functionalities in a wide variety of devices. The functional elements to the system are a device housing, a power supply module, and one or more activation modules that are activated by a particular motion of the housing, such as when the device housing is able to at least partially spin or rotate about one or more axis' of rotation. The disclosed activation modules include a centrifugally activated electronic system that allows a device's functionality to be turned on or off by moving the device's housing in a particular fashion. In this way, a device equipped with the disclosed centrifugally activated electronic system does not need to have a manual ON/OFF switch or fragile mechanical switch. Instead, the disclosed system allows one or more of a device's functionalities to be activated (or de-activated) when the device's housing moves in the proper manner, while reducing unwanted activations that would be caused by slight and/or unintentional movement. Any sort of promotional product may be equipped with the disclosed false activation reducing centrifugal activation system, including, but not limited to, toys for children, pet toys, novelty devices, and corporate giveaways.

### CROSS-REFERENCES TO RELATED APPLICATIONS

This is a utility patent application, taking priority from provisional patent application, Ser. No. 60/927,569 filed on May 3, 2007.

### BRIEF DESCRIPTION OF THE INVENTION

The present invention is directed to motion sensitive activation systems, and more particularly to centrifugal activation systems that reduce false activations in devices equipped with centrifugally-activated functionalities.

### STATEMENT AS TO THE RIGHTS TO INVENTIONS MADE UNDER FEDERALLY SPONSORED RESEARCH OR DEVELOPMENT

Not Applicable.

### REFERENCE TO A “SEQUENCE LISTING,” A TABLE, OR A COMPUTER PROGRAM LISTING APPENDIX SUBMITTED ON A COMPACT DISK

Not Applicable.

### BACKGROUND OF THE INVENTION

Motion activated devices, toy novelty devices, and promotional products are well known to children, adults, and those skilled in the art. Many devices have been developed that respond to physical movement by activating some function. There are, for example, toy balls of all shapes and sizes that light-up or make noise in response to movement or physical touching, pet toys that speak in response to movement, toy dolls that move and speak in response to observed motion, and many more.

The marketplace is full of toy balls that resemble athletic balls in their shape and dimensions, but which have various additional novelty features. Some examples of such toy balls are: footballs that whistle as they fly through the air, Frisbees that light up with multicolor displays, and soccer balls that glow in the dark, etc. All of the novelty devices and toy balls known in the art have one or more serious drawbacks that greatly limit their functionality or their ease of use. Motion activated devices have also been used in many other applications outside of the toy and novelty item industries.

Many devices equipped with motion-activation systems are far too easy to accidently activate. When this is the case, a user may become frustrated with his or her inability to stop the device from activation, or once it has activated to get the device to turn off. Or, if the motion-sensitive device becomes activated unbeknownst to the user, the device may continue to run for long periods of time and thus drain the available power supply. In this situation, the device may completely drain its power supply, usually an imbedded battery, which may be difficult, expensive, or even impossible to replace. The mechanical components of the device may even break down prematurely because of the additional accidental use. Such accidental activation may leave the device unavailable for its intended use at the proper time and place.

On the other end of the spectrum, devices designed to have additional functionality beyond their “regular” use (such as a football that is illuminated by a multicolor light display) may be too difficult or cumbersome to activate. Such a device may have an ON and OFF manual button or switch. In the case of a football or a Frisbee, a manual ON/OFF button means that the user must always travel to the location of the device to turn it off. If a user has just thrown such a football or Frisbee, it will continue to flash or display its lights even after coming to rest and/or becoming abandoned by the user, because unless a user manually turns a switch or presses a button, the device will remain in either the same ON state or OFF state in which it began. Another drawback to such an ON/OFF button or switch is that it must be accessible to a user. This means that the button or switch must be on the outside surface of such a device, probably either protruding from the surface of the ball or recessed from the surface of the ball. In the case of an athletic-type ball or disc, such a protruding (or receded) button/switch may prove to be an annoyance during routine use of the ball or disk because it alters the normally smooth surface. Further, a protruding item would be easily damaged.

A few more sophisticated devices on the market try to solve these problems. More specifically, several devices are known in the art that attempt to utilize centrifugal motion to activate their functionality. These devices have their own drawbacks.

One such novelty device is a flying disc with an electronic signaling device activated by a centrifugal switch, disclosed in Samuel, U.S. Pat. No. 3,798,834. The design disclosed in Samuel is very primitive and cumbersome. A battery is secured within a chamber by a spring and the element it is intended to operate. The circuit is completed by a small, weighted contact element that moves into engagement with one terminal of the battery during rotation of the flying disc. The mechanical nature of the spring-operated centrifugal switch used in Samuel is highly prone to failure after prolonged or rigorous use. Even more detrimental, however, is that Samuel makes use of a single centrifugal switch per functionality to be activated. This means that not only will the centrifugal switch activate during flight, but will often activate accidentally. For example, dropping the Samuel disc, even from a small height, will be enough to cause the weighted spring to close the circuit and activate the functionality. Alternatively, moving the Samuel disc quickly, or with some acceleration, in a straight line—as would happen when a supply-chain worker, a retail worker, or a user carries the disc from location to location—will cause the functionality to activate. Such easy and unintended activation is undesirable.

Another similar device is a sound and light emitting football disclosed in Hamilton, U.S. Pat. No. 5,316,293. Hamilton describes a football that when centrifugally activated can emit sound or light. The Hamilton centrifugal activation system utilizes one weighted arm switch which is designed to move and thus close the circuit in response to spinning flight. There are several drawbacks to such a design. The mechanical components of the weighted arm switch are likely to break after prolonged or rigorous use, and rigorous use should be expected for a football. More importantly, the use of only a single centrifugal switch proves very ineffective in such a motion activated toy ball. As in the Samuel disclosure, the Hamilton design is overly easy to activate, meaning that the system will regularly be activated accidently. For example, dropping the Hamilton football, even from a small height, will be enough to cause the weighted arm to close the circuit and activate the sound and/or the light display. Alternatively, moving the Hamilton football quickly, or with some acceleration, in a straight line—as would happen when a supply-chain worker, a retail worker, or a user carries the football from location to location—will cause the functionality to activate. Such easy and unintended activation is undesirable for a number of reasons, chiefly because it will drain the power supply prematurely. It could also be dangerous, if, for example, the ball was activated in a car while in transport due to a bump in the road.

It is apparent that there is a need for a motion-activation system that can reduce or eliminate accidental activations. It is also advantageous for such a system to be able to withstand prolonged and rigorous use. The presently disclosed centrifugal activation system fulfills this market need by greatly reducing accidental activations while being resistant to severe or prolonged use. The disclosed system is able to achieve these goals by utilizing at least two centrifugal switches in combination to reduce accidental activations, by positioning the switches within an object to take advantage of the object's shape and motion; and by utilizing an elegant electrical circuit design that minimizes mechanical components to reduce long-term mechanical fatigue.

### BRIEF DESCRIPTION OF THE SEVERAL THE DRAWINGS

FIG. 1 is a schematic diagram illustrating an example of the type of circuitry that may be used to implement the false activation reducing centrifugal activation system;

FIG. 2 is a cross-sectional diagram of a football equipped with LED lights and with the false activation reducing centrifugal activation system of the present invention;

FIG. 3a is a view of the football from FIG. 2 when the football is static and FIG. 3b is a view of the same football when it is spinning after being thrown, each showing more detail regarding the tilt switches;

FIG. 4 is a schematic diagram illustrating an example of the false activation reducing centrifugal activation system as used to control an array of eight LEDs; and

FIG. 5 is a cross-sectional diagram of a heat resistant clamshell substructure used to encase circuitry for implementing the false activation reducing centrifugal activation system within a ball made with foamy material.

### DETAILED DESCRIPTION OF THE INVENTION

The present invention is directed to a false activation reducing centrifugal activation system. The system is an activation system that may be used to activate a wide variety of functionalities in a wide variety of devices. The functional elements to the system are a device housing, a power supply module, and one or more activation modules that are activated by a particular motion of the housing, such as when the device housing is able to at least partially spin or rotate about one or more axis' of rotation. The disclosed activation modules include a centrifugally activated electronic system that allows a device's functionality to be turned on or off by moving the device's housing in a particular fashion. In this way, a device equipped with the disclosed centrifugally activated electronic system does not need to have a manual ON/OFF switch or fragile mechanical switch. Instead, the disclosed system allows one or more of a device's functionalities to be activated (or de-activated) when the device's housing moves in the proper manner, while reducing unwanted activations that would be caused by slight and/or unintentional movement.

The false activation reducing centrifugal activation system may be implemented in any device where activation of an electronic circuit should depend on a particular type of motion of the device's housing. Such suitable devices include, but are not limited to, promotional products such as children's toys, pet toys, corporate giveaways, and novelty items. As used throughout this application, the phrase “promotional product(s)” is meant to include commercial toys and novelty devices which may be sold at retail as well as devices given away at corporate events and functions. An example application of the disclosed system is in a novelty toy foam football, the surface perimeter of which is lined with LEDs that illuminate when the football rotates about its longitudinal axis, as would naturally occur when a user throws the football with some degree of spiral spin. Another example application is a pet toy designed to keep a pet's interest without the need for human intervention, the pet toy being capable of automatically moving erratically across a surface in response to the pet pushing or hitting the toy in some fashion. Both example applications take advantage of the disclosed system to activate one or more device functionality in response to the device housing's rotation about an axis, while advantageously avoiding unintended functionality activations. Both applications will be explained in detail below.

There are, of course, many permutations of these example applications, as well as many other possible applications of the disclosed false activation reducing centrifugal activation system. For example, the pet toy might be oddly shaped, like a jumping jack, so it will bounce erratically when dropped. Such a toy might require a pair of switches that activate when moved around one axis and one or more additional pairs of switches that are activated when the device is moved in another axis of rotational motion, not around the one axis. Thus, the device may not activate simply when moved or carried around by an animal, but once triggered by rotational motions will activate when dropped, or each time it bounces after being dropped, at least for some predetermined period of time.

An advantage to the false activation reducing centrifugal activation system herein disclosed is that while it is not overly difficult for a user to intentionally activate such a system, it is not overly easy either. The requirement of at least two tilt switches per type of motion ensures that simply tilting the device housing relatively slowly in one direction or another will not activate the system. Nor will simple straight line movement on its own activate the system. As will be described below in one embodiment, activation of the disclosed system requires at least partial rotation creating sufficient centrifugal force. Such a threshold level of required centrifugal force ensures that a device equipped with the disclosed system may not be accidentally activated, thus avoiding unnecessary or unwanted consumption of the power supply. The requirement of a threshold centrifugal force level also allows such a device to be carried from one location to another without activation, because such carrying would only involve straight-line movement. Thus a device may be transported, even at a very high rate of speed or acceleration, without system activation. In other embodiments, such a system could also be equipped with one or more additional switches that are activated by straight line movement, but must be accompanied by some additional motion, such as rotation about an axis within a predetermined period of time to fully activate a device.

The disclosed system's characteristic of relative difficulty of accidental or unwanted activation has all sorts of beneficial applications. Devices equipped with the false activation reducing centrifugal activation system may be manufactured without worry that basic manufacturing-related physical movements will activate the system and thus prematurely drain the power supply. For example, production of the illuminateable football example, described below, may be designed so that the power supply is embedded within the football early-on within the manufacturing cycle without worry that subsequent physical transportation of the football to other steps within the manufacturing cycle will accidentally activate the illumination system and drain the battery. The football may then be shipped to retail stores and handled by supply-chain workers and retail workers, again without worry of accidental activation and premature battery drain.

A further benefit to the disclosed system's characteristic of relative difficulty of accidental or unwanted activation is that such a device will not accidently activate while in the user's possession. It is disadvantageous to have an overly sensitive motion activated device because such a device could easily activate while sitting in a closet. An owner of such a device may be moving other items on the other side of the closet, and set off a chain reaction of moving closet items which in turn bumps the motion-activated device. If the device is overly easy to activate, just a small bump will set it off and waste its power supply. But with the disclosed false activation reducing centrifugal system, such a bump will not activate a device's functionality. As will be described, one embodiment of the disclosed system requires at least a pair of opposing tilt switches to be closed at the same time, meaning that bumping, slow turning, or even high-impact jarring of the system is not enough to activate the system—only centrifugal rotation is enough to activate the system.

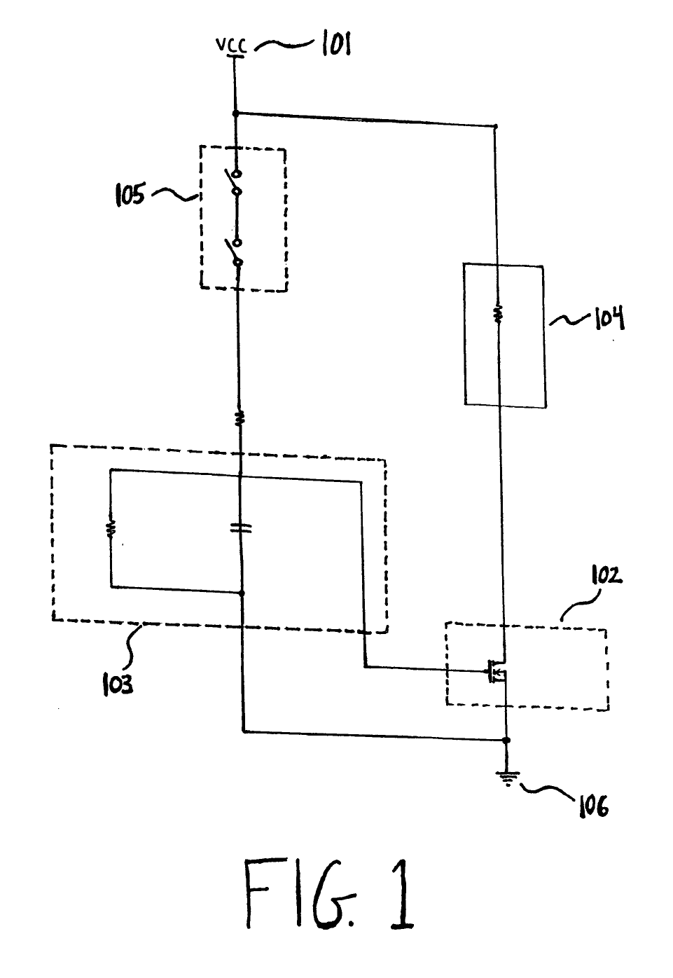

FIG. 1 illustrates an embodiment of an electric circuit configuration designed to implement the disclosed false activation reducing centrifugal activation system. The FIG. 1 circuit can be incorporated into a system further comprising a device housing, a power source, and a functionality (also referred to as a load) to be powered by the power source. FIG. 1 provides a simple, low component count circuit layout to separate a power supply 101 from a load 104 via a transistor 102. A resistor-capacitor parallel configuration 103 connected to the transistor 102 provides a time constant to the system. Any combination of circuitry designed to provide the time constant may generally be described as a time module, with one example illustrated in FIG. 1. When tilt switches 105 are closed charge flows into the resistor-capacitor parallel configuration 103, charging the capacitor. Charge from the resistor-capacitor parallel configuration 103 then flows to a transistor 102 gate terminal, which in turn allows charge to flow through transistor 102's source and drain terminals to power load 104. When at least one of tilt switches 105 opens, charge ceases to flow to the resistor-capacitor parallel configuration 103. But the charge stored in 103's capacitor continues to flow to transistor 102's gate terminal for some predetermined time period, allowing charge to continue to flow through the source and drain terminals of transistor 102 and to power load 104 for the predetermined time period. This configuration may also be utilized to provide a power on delay.

Two opposing tilt switches 105 per axis of rotation may be connected in series to provide for centrifugal activation of the system. A tilt switch is a type of electrical switch which can either allow or interrupt the flow of electric current in an electrical circuit, depending on the tilt switch's physical position or alignment relative to the direction of earth's gravitational pull. A tilt switch consists of one or more sets of electrical contacts in a sealed glass envelope which contains a bead of metal (such as mercury, etc.) or any other suitable material. The bead sealed within the glass envelope does not necessarily have to be a metal—it can be any material suitable for conducting electrical current to complete the circuit while also being amenable to the earth's gravitational pull—but this application will refer to the suitable material as a bead of metal. Similarly, the tilt switch's sealed envelope need not be glass. The sealed envelope may instead be plastic, metal, or any other suitable material. Tilt switches most commonly use sealed glass envelopes, but the phrase “sealed envelope” is meant to encompass any such suitable material used to enclose the one or more sets of contacts and the gravitationally amenable bead. The sealed envelope may also contain air or some other inert gas, or instead may be a vacuum.

In the most common application of a tilt switch, gravity is constantly pulling the bead of metal to the lowest point in the sealed envelope. When the tilt switch is tilted in the appropriate direction, the metal bead touches a set of contacts, thus completing an electrical circuit through those contacts—in other words, closing a switch. Tilting the tilt switch the opposite direction causes gravity to pull the metal bead away from the set of contacts, thus breaking the electrical circuit—opening the switch. As stated, centrifugal activation may be achieved by using two opposing tilt switches connected in series at 105. In order to complete the circuit and activate the system, both tilt switches must be closed.

A functional circuit able to implement the disclosed false activation reducing centrifugal activation system may obviously be configured in any number of ways. The only essential elements to such a circuit are: one or more pairs of opposing tilt switches 105 configured in series so that both tilt switches within a pair must be closed in order to form a circuit. As should become apparent to those skilled in the art, the exact placement or use of resistors, resistor-capacitor parallel configurations 103, and/or transistor 102 will depend upon what sort of load 104 is to be powered by the power supply 101. As stated, FIG. 1 is only an example.

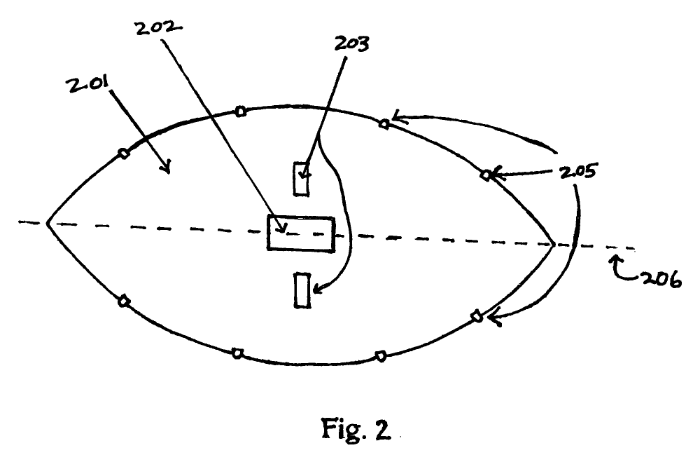

The circuit as described above and seen in FIG. 1 may be utilized in practically any device. One exemplary embodiment of a novelty device is an athletic ball, such as a football. FIG. 2 illustrates a football 201 utilizing the presently disclosed system. Power for the system is supplied by a battery 202. The load in this football embodiment is comprised of an array of light emitting diodes (LEDs) 205, but the load could be almost anything that can be powered by the disclosed system: any other type of light producing module, a sound producing module, a movement producing module, a heat producing module, a microcontroller module which itself could be used to activate and/or control a wide variety of functionalities, etc. Two tilt switches 203 may be placed on opposing sides of the football 201. The word “opposing” here refers to the placement of the tilt switches on opposing sides of an axis of rotation 206, preferably 180 degrees apart around axis 206, and preferably equidistant from the axis of rotation 206. Equidistant placement from the axis of rotation is optimum because such a design will have the least impact on the weight distribution of a football and therefore the least impact on the spin and flight of a thrown football. But in regard to activating the electric circuit, the placement of the two (or possibly more, as will be described below) tilt switches need not be exactly equidistant from the axis of rotation. As long as the two tilt switches are placed on opposite sides of the axis of rotation, the centrifugally activated electronic system herein described will operate to some degree. The football 201, just like any American-style football, is designed to rotate when thrown about an axis 206 created by an imaginary line running from one pointed tip to the other pointed tip. Axis 206 may also be described as the football's longitudinal axis. When the football 201 is thrown, the football 201 will spin along axis of rotation 206, at least minimally. When a thrown football spins perfectly about the axis of rotation, it is generally called a spiral. A spiral is an ideal throw, but almost any throw, however imperfect, will spin about axis 206 at least somewhat. As football 201 spins about axis of rotation 206, the tilt switches 203 also spin about axis of rotation 206.

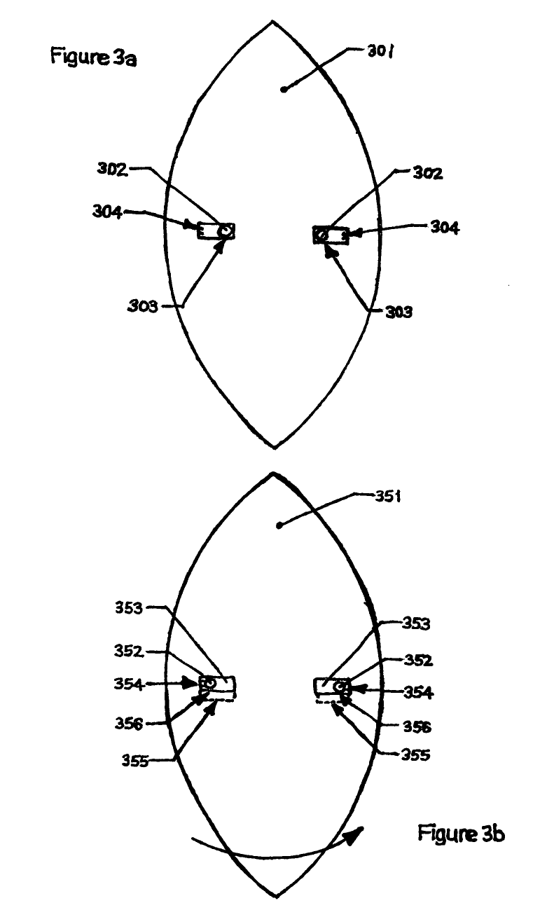

FIGS. 3a and 3b illustrate the centrifugal activation system as practiced in a thrown football. Before the football is thrown, the football is not spinning and is at rest—this is referred to as a static football 301 and is illustrated by FIG. 3a. In this static state, one or both of the opposing tilt switches are in an open position, meaning that the electrical circuit is not completed and so the load, which as discussed above may be an array of LEDs, is not powered by the power supply. More specifically, one or both of the tilt switches are in an open position because one or both of the beads of metal 302 are in open position 303 away from the electrical circuit contacts 304. As the football is thrown 351, as illustrated in FIG. 3b, it spins about the axis of rotation and therefore the opposing tilt switches spin with the football 351. Each bead of metal 352 in each tilt switch moves towards the outside of the sealed envelope 355, in a direction that is away from the axis of rotation of the thrown football 351. The tilt switches should be situated so that this outward movement of the beads of metal 352 closes the switches. In other words, the beads of metal 352 move from an open position 353 some distance from the electrical circuit contacts 354, to a closed position 356 in contact with the electrical circuit contacts 354. When the beads of metal 352 in both of the tilt switches are in contact with the electrical circuit contacts 354, the circuit is completed and the load is powered by the power supply.

As the football flies through the air after being thrown, the football continues to spin about the axis of rotation. This spinning keeps the beads of metal in the closed position, keeping the electrical circuit completed and the relevant load powered, due to a force sometimes described as centrifugal force. A common way of thinking about this situation is that the spinning device housing, the football in this example, creates a force that propels the beads of metal away from the axis of rotation. This is often referred to as centrifugal force (Latin for “center fleeing” force). Properly understood, however, there in fact is no force propelling the beads of metal away from the axis of rotation. In reality, what is happening is that there is a lack of centripetal force. Whenever an object moves in a circular path—the spinning football in this example—the object is accelerating because the velocity is constantly changing direction. All accelerations are caused by a net force acting on an object. In the case of an object moving in a circular path, the net force is a special force called centripetal force (Latin for “center seeking”). So a centripetal force is a center seeking force, meaning that the force is always directed toward the center of the circle. Without this force, an object will simply continue moving in straight line motion. The centripetal force acting on the football is imparted by the throwing motion of the person who threw the football. This centripetal force keeps the football, and the tilt switch secured to the football, moving in a circular path—what this disclosure refers to as spinning about the axis of rotation. But the beads of metal are not secured to the football; they are free to move within the sealed envelopes of the tilt switches. Because they are free to move, the beads of metal are not subject to the same centripetal force that keeps the football and the tilt switches spinning about the axis. The beads of metal, therefore, continue to move in a straight line even as the football and the sealed envelopes move in a circular path. Looking to FIG. 3b again, this straight-line movement is what moves the beads of metal 352 from their initial open position 353 away from the electrical circuit contacts 354, to the closed position 356 in contact with the electrical circuit contacts 354. So it is a lack of centripetal force acting on the beads of metal that drives the operation of the tilt switches and thereby the disclosed activation system for use in devices such as the illuminated football example.

Nevertheless, the physical workings of the disclosed system are more easily conceptualized and understood when described as “centrifugally activated,” and so that convention will be utilized throughout this application. So, although speaking of “centrifugal force” is not quite correct from a pure physics standpoint, it simplifies the discussion and is in fact what humans observe in relevant situations. Throughout this disclosure, the phrase “centrifugal force” has been and will generally be used in place of the phrase “a lack of centripetal force.”

While the system remains activated by constant centrifugal force, the load remains powered. When the football comes to rest, meaning that the football has stopped spinning about the axis of rotation, the system may be designed so that the load remains supplied with some form of power for a short time even while one or both of the tilt switches revert to their open position. This may be accomplished in many ways, with one example being illustrated in FIG. 1. When the tilt switches 105 are both closed thus completing the circuit, the resistor-capacitor module 103 is charged with power from the power supply 101. Once the resistor-capacitor module 103 is fully charged, charge begins to flow through the entire circuit thus powering load 104. When one or more tilt switches 105 open, the circuit is broken. At this time, charge stored in resistor-capacitor module 103 continues to flow to transistor 102 until such stored charge is dissipated. While the stored charge continues to flow, transistor 102's source and drain terminals remain conductive and thus load 104 remains powered. Once the stored charge is dissipated, transistor 102 ceases to be charged, the source and drain terminals cease to conduct charge, and load 104 ceases to be powered. This time period during which the load 104 remains supplied with power after one or more tilt switches 105 open is called the “hang time” of the system. The hang time can be varied to a desirable length of time using a simple resistor capacitor (RC) load to control a transistor 102 (either a FET or BJT). By varying the values of the resistor and capacitor in the resistor capacitor module 103, the hang time can be adjusted. In the illuminate football example, a purpose of the hang time is to provide users the ability to track the football for a short period of time after it comes to rest in low or no light environments.

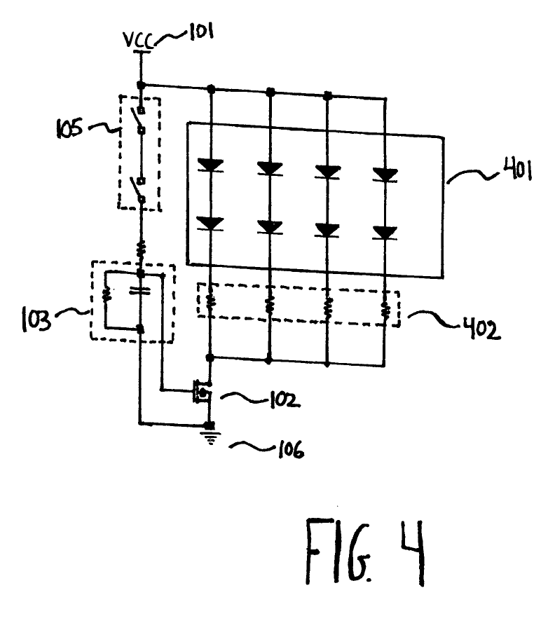

FIG. 4 illustrates an example of a circuit incorporating the disclosed false activation reducing centrifugal activation system as utilized to control an illuminatable football illuminated by an array of eight LEDs. The eight LEDs 401 are arranged so that there are four parallel branches of LEDs connected in series. Each electrical path through a LED may require a resistor 402 in series with the LED(s) to limit the electrical current passing through the component to a safe value. Of course, an LED array can be configured in any number of various ways to allow the use of various power sources.

The above described centrifugally activated illuminatable football example may be designed and manufactured in any number of ways. The ball can of course be made of almost any suitable material. One exemplary design is to use a foam substance much like many soft and/or squishy footballs and other balls common in the marketplace. A ball of the desired size and shape is made by blowing heated foamy material into a mold of the appropriate dimensions, and then allowing the foamy material to cool. One way to produce the foamy material, well known in the industry, is by the reaction of polyester with a diisocyanate while carbon dioxide is liberated by the reaction of a carboxyl with the isocyanate. Polyester resin reacts with a compound while CO₂ is simultaneously released by another reaction. It is the release of the CO₂ gas that creates open pockets within the polyurethane that, in turn, makes the material soft and light. Such toy balls are often marketed to kids because they are fully functioning toy balls and yet they are soft and so they do not hurt kids when caught or thrown. Such soft and/or squishy foam balls are also popular with persons of all ages because they can safely be used indoors without breaking household items. A soft and/or squishy foam football may be made illuminatable by incorporating the false activation reducing centrifugal activation system herein disclosed.

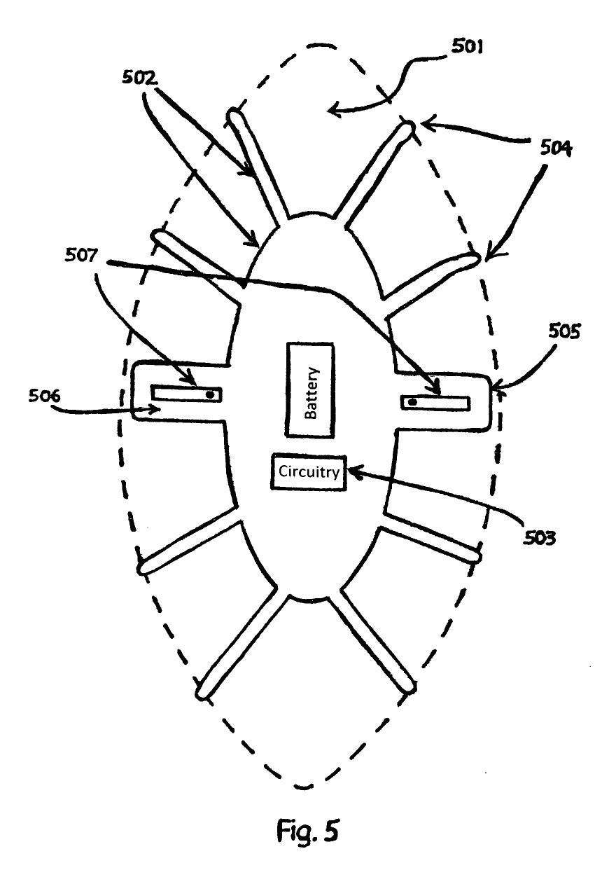

To produce such a centrifugally activated foam ball, a flexible plastic clamshell substructure may be used to encase the previously described circuitry and battery. (See FIG. 1 for an exemplary circuit design.) FIG. 5 illustrates an example of the proposed clamshell substructure production design. The clamshell substructure 502 may be made with a flexible and heat resistant material; for example, a type of silicon or plastic. Clamshell substructure 502 may instead be made of a foam material, possibly a type of sturdy but flexible foam, if heat resistance is less of a consideration. The clamshell substructure would, for the football example, have a relatively large middle pod for placement of the larger circuit elements (such as a transistor and/or a resistor-capacitor parallel module, for example) and branches leading to the outside of the football form for LEDs 504 to be placed. The clamshell substructure 502 may also have two relatively thicker branches leading to a recharge port 505 and a counter-weight port 506. The circuitry may be designed so that a power supply, a battery for example, may be placed within the large middle pod of the clamshell substructure 502. If the battery is rechargeable, one example of a way to recharge the battery would be to have an accessible recharge port 505 that a user may connect to an outside power source in order to recharge the battery. If the system were designed to utilize a recharge port, then an opposing substructure counter-weight branch 506 would be necessary to counter-balance the additional weight of the recharge module, so that the football would spin correctly when thrown. In such a substructure 502 design, tilt switches 507 would be placed in the thicker branches 505 and 506.

The appropriate circuitry 503, including tilt switches 507 and LEDs 504, would be laid out and encased within the clamshell substructure 502. The substructure 502 is described as “clamshell” because one way to accomplish the encasement is to design the substructure as a lower half and an upper half, like a clam. The circuitry 503, tilt switches 507 and LEDs 504 would be placed in the lower half and then the upper half would be laid on top and secured to the lower half, thus fully encasing the delicate circuitry, etc., inside the plastic, heat-resistant substructure 502. The LEDs 504 could be coated with any appropriate material—such as a translucent plastic protective layer, for example—designed to protect the LED bulbs from ordinary football wear-and-tear.

Once the substructure is assembled with the circuitry, etc. enclosed, the substructure may be suspended inside a mold. The appropriate foamy material, which may be quite hot (hence, the heat-resistant characteristic), may be blown around the substructure to create the desired football shape.

The preceding is only one example of how a toy ball equipped with a centrifugally activated electronic system may be designed and produced. The ball may be practically any size and shape: spherical such as a baseball or a basketball, longer more like a javelin, flatter more like a disk, or any shape in between. The ball may be made of practically any material: it need not be a foamy material but may instead be hard plastic or anything in between. The substructure may also be made from any other material, such as metal. Or there may be no need for a substructure, depending on the material used to make the ball itself. For example, a leather football, much like a football used by the National Football League (the “NFL”) or the National Collegiate Athletic Association (the “NCAA”), may be equipped with a centrifugally activation system. Most leather footballs are inflatable, enclosing pressurized air within an internal bladder made of one or more layers of plastic, rubber, woven fabric or other material. The centrifugal activation system components can be sown or otherwise attached to the inside of the bladder, for example. In this case, a rigid or protective substructure may not be necessary. A leather football, just like any device equipped with the centrifugal activation system, can be designed to activate any number of functionalities. For example, such a football could be equipped with a heating module that would be activated by centrifugal motion. Such a design is quite practical as football is often played outdoors during the cold fall and winter months.

Based on the geometry of the device's housing, pairs of tilt switches may be connected together to provide different rotational effects on the system. The above described football example only uses two tilt switches opposing each other across one axis of rotation. But a centrifugal activation system could easily be designed to take advantage of more than one axis of rotation, thus calling for more than one pair of opposing tilt switches. For example, in the case of a sphere, two, four, or six tilt switches, two per axis of rotation, may be connected serially to require the centrifugal force of either one, two, or three axis' in order to activate the power supply to the load. Or, the device may be designed so that one pair of opposing tilt switches is in parallel circuit configuration to another pair of opposing tilt switches. In this way, the device may respond to any sort of turning or spinning movement, no matter which axis of rotation is utilized. The practical applications of such parallel and series configuration of tilt switch pairs are almost limitless. One example is that a ball could be designed so that rotation about one axis results in illumination of blue LEDs, rotation about another axis results in illumination of red LEDs, while rotation about a third axis results in production of a auditory sound. Another interesting possible application involves more than one pair of tilt switches positioned at different radii along the same axis of rotation. In such an example, if the ball spins at a certain rate of rotation, the inner-most pair of tilt switches is activated and the ball illuminated green, for example. If the same ball then spins at a certain faster rate of rotation, the outer-most pair of tilt switches is activated and the ball then also illuminates orange, for example. Such a configuration could be utilized as an accelerometer, where different functionalities are activated at different rates of spin. Of course, any combination of serial and parallel configurations for the pairs of opposing tilt switches is possible.

Additional elements can be added to a ball equipped with the false activation reducing centrifugal activation system in order to increase a user's enjoyment of the ball. For example, inertial switches may be added for activation of additional functionalities when a ball so equipped hits a target. In this example, the ball may illuminate purple LEDs while flying through the air, due to an incorporated false activation reducing centrifugal activation system like that herein disclosed, and then may illuminate green LEDs when it hits its target, due to additional incorporated inertial switches. Of course, the inertial switches may be designed to activate any additional functionality, such as a sound producing module.

A second proposed implementation of the centrifugally activated system besides an illuminatable football is in the movement of a pet-toy device across a surface. Such a pet-toy's intended use is primarily for typical household pets such as cats and dogs, but may also be suitable for any other pet, such as a hamster, a bird, etc. The disclosed system could be used to keep a cat or a dog interesting in the toy even without human intervention. The disclosed system would be embedded in the ball as previously described to include at least a pair of opposing tilt switches. When a pet pushes, hits, or moves the toy device housing to a sufficient degree the centrifugal activation system would connect the power source to the load, and the load would remain powered for as long as the hang time is configured for. The load in this example may be a rotating weight about an axis which would cause the ball to roll across a surface. For example, if a pet pushed a centrifugally activated ball across a floor, the ball would of course spin. The spin would activate the system as discussed, and the power supply would be connected to the load. The load in this case is a small motor designed to move a weight, or a weighted element, hidden inside the ball. The weight would be moved by the motor from its original position on one side of the inside of the ball to a second position within the ball, in such a manner as to cause the ball to move erratically across the surface. The mechanized movement of the weight within the ball can be designed to repeat, so as to increase the movement. This erratic movement would be of great interest to the pet and would compel the pet to chase and/or push the ball again, thus activating the centrifugally activated system again, again causing the ball to move erratically. In this way the pet is able to play with the ball all on its own and retain interest, even without human intervention.

The centrifugally activated system may be utilized in many ways to create pet toys such as a dumbbell or jack shaped toy that could be designed to activate when dropped in a particular way. Other possible useful loads that may be activated could include LEDs, noise making modules, scent-releasing modules, a microcontroller used to activate and/or control any sort of functionality, or anything imaginable that would prolong a pet's interest in a toy that can be powered by a reasonable power source. It is also possible to design a pet-toy device with a combination of different types of loads for each axis of rotation. For example, spinning the device around one axis produces an interesting sound while spinning the device around a different axis produces a multi-colored LED display. The possibilities are numerous.

The examples herein described are all comprised of a power supply module that is connected to the relevant load when the disclosed system is activated. The power supply module could take many different forms. The supply could be some sort of a battery or capacitor imbedded within device housing. The battery imbedded within the device housing could be a single use battery, such as an alkaline battery with a relatively short life span or a Lithium Iron Disulphide battery with a relatively long life span, for example. In the case of a single use battery, a device so equipped would probably be relatively inexpensive and could be considered a disposable toy which a user throws away after the battery power is drained.

The imbedded battery could instead be a rechargeable battery, such as a Nickel-cadmium battery or a Rechargeable alkaline battery, for example. In the case of a rechargeable battery, the device housing may have a recharge port (see recharge port 405 in FIG. 4) that allows a wire to be inserted into the interior of the device to connect the battery to an outside power source. Or, if a device were equipped with an inductive coil charging module, the device could be designed so as to be placed in close proximity to a charging base station. In this example, the battery or capacitor would be recharged through a process of electromagnetic induction, whereby a charging station or charging wand induces a current inside the adjacent device equipped with the centrifugal activation system, which transfers power to the batteries imbedded within.

A device equipped with the disclosed false activation reducing centrifugal activation system could also be designed so that a user could remove a fully-drained power supply, such as an alkaline battery, and replace it with a new or newly recharged battery. In this example, the device housing may have a power source port opening on its surface.

Of course, any sort of power supply that can be contained within a device equipped with the disclosed system may be utilized.

While the presently disclosed invention has been illustrated and described herein in terms of several preferred embodiments and several alternatives of each embodiment associated with the false activation reducing centrifugal activation system for use in novelty and other devices, it is to be understood that the various components of the combination and the combination itself can have a multitude of additional uses and applications. Accordingly, the invention should not be limited to just the particular description and various drawing figures contained in this specification that merely illustrate a preferred embodiment and application of the principles of the invention.

We claim:

1) An activation system for activating one or more functionalities of a device, comprising:
a device housing capable of at least partial rotation about one or more axes;
a power supply module capable of powering the one or more functionalities of the device; and
one or more activation modules that are configured to reduce a false activation and that activate the one or more functionalities in response to a minimum threshold level of motion of the device housing about the one or more axes.

2) The claim as recited in claim 1, wherein a functionality of the one or more functionalities of the device involves illuminating the device.

3) The claim as recited in claim 1, wherein a functionality of the one or more functionalities of the device involves producing a sound.

4) The claim as recited in claim 1, wherein a functionality of the one or more functionalities of the device involves producing heat.

5) The claim as recited in claim 1, wherein a functionality of the one or more functionalities of the device involves producing a smell.

6) The claim as recited in claim 1, wherein a functionality of the one or more functionalities of the device involves activation of a microcontroller, the microcontroller capable of controlling one or more functionalities.

7) The claim as recited in claim 1, wherein a functionality of the one or more functionalities of the device involves moving a weight within the device housing about the one or more axes.

8) The claim as recited in claim 7, wherein movement of the weight causes the device to move erratically across a surface.

9) The claim as recited in claim 1, wherein the one or more activation modules each include at least two tilt switches that must both be in a closed position in order to activate the one or more activation modules.

10) The claim as recited in claim 9, wherein the at least two tilt switches are configured in series and must be in the closed position at approximately the same moment in time in order to activate the activation modules.

11) The claim as recited in claim 10, wherein the at least two tilt switches are positioned on opposing sides of a longitudinal axis of the device housing, and wherein rapid rotation of the device housing about the longitudinal axis causes both tilt switches to close at approximately the same time.

12) The claim as recited in claim 1, wherein the power supply module comprises a rechargeable battery or rechargeable capacitor.

13) The claim as recited in claim 12, wherein the rechargeable battery or rechargeable capacitor is capable of being recharged through electromagnetic induction.

14) The claim as recited in claim 1, wherein the power supply module comprises a disposable or replaceable battery.

15) The claim as recited in claim 1, wherein one activation module of the one or more activation modules includes at least three tilt switches and wherein any two tilt switches of the at least three tilt switches must be in a closed positioned in order to activate the activation module.

16) The claim as recited in claim 1, wherein the device housing includes a central area and a plurality of arms extending from the central area, wherein the activation module comprises a tilt switch positioned in at least two of the arms, and wherein activation requires exactly two of the tilt switches to be closed at any one time.

17) The claim as recited in claim 1, further comprising a time module that operates in conjunction with the one or more activation modules to enable one or more functionalities to remain activated for a predetermined period of time.

18) An activation system for activating one or more functionalities of a promotional product comprising:
a device housing capable of at least partial rotation about one or more axes;
a power supply module capable of powering the one or more functionalities of the promotional product; and
one or more activation modules that are configured to reduce a false activation and that activate the one or more functionalities in response to a minimum threshold level of rotation of the device housing about the one or more axes.

19) The claim as recited in claim 18, further comprising a time module that operates in conjunction with the one or more activation modules to enable one or more functionalities to remain activated for a predetermined period of time.

20) The claim as recited in claim 18, wherein the promotional product is a football, wherein the device housing is comprised of a foamy material, and wherein an activation module of the one or more activation modules includes at least one pair of tilt switches that are positioned on opposing sides of a longitudinal axis of the device housing and that are operative to activate a functionality when the football spins about the longitudinal axis.

21) The claim as recited in claim 20, further comprising a time module that operates in conjunction with the activation module to enable the one or more functionalities to remain activated for a predetermined period of time.

22) The claim as recited in claim 20, wherein the functionality is illumination.

23) The claim as recited in claim 22, wherein illumination is achieved by a plurality of LED lights.

24) The claim as recited in claim 23, wherein the plurality of LED lights are arranged along a perimeter of the football.

25) The claim as recited in claim 20, where the activation modules and the power supply module are encased within a flexible substructure.

26) The claim as recited in claim 18, wherein the promotional product is a football, wherein the device housing is comprised of at least an inflatable shell, and wherein an activation module of the one or more activation modules includes at least one pair of tilt switches that are positioned on opposing sides of a longitudinal axis of the device housing and that are operative to activate a functionality when the football spins about the longitudinal axis.

27) The claim as recited in claim 18, wherein the one or more activation modules include:
a first activation module having a first pair of tilt switches that are positioned on opposing sides of a longitudinal axis of the promotional product at a first radius from the longitudinal axis and that are operative to activate a first functionality when the promotional product spins about the longitudinal axis at a first rate of rotation; and
a second activation module having a second pair of tilt switches that are positioned on opposing sides of the longitudinal axis at a second radius from the longitudinal axis and that are operative to activated a second functionality when the promotional product spins about the longitudinal axis at a second rate of rotation.

28) The claim as recited in claim 27, further comprising a time module that operates in conjunction with the first activation module to enable the first functionality to remain activated for a first predetermined period of time and that operates in conjunction with the second activation module to enable the second functionality to remain activated for a second predetermined period of time.

29) The claim as recited in claim 27, wherein the first functionality is illumination in a first color, and wherein the second functionality is illumination in a second color.

30) The claim as recited in claim 18, wherein the one or more activation modules include:
a first activation module having a first pair of tilt switches that are positioned on opposing sides of a longitudinal axis of the promotional product and that are operative to activate a first functionality when the promotional product spins about the longitudinal axis; and
a second activation module having an inertial switch that is operative to activate a second functionality when the promotional product hits a hard surface.

31) The claim as recited in claim 18, wherein a functionality of the one or more functionalities of the promotional product involves producing a sound.

32) The claim as recited in claim 18, wherein a functionality of the one or more functionalities of the promotional product involves producing heat.

33) The claim as recited in claim 18, wherein a functionality of the one or more functionalities of the promotional product involves producing a smell.

34) The claim as recited in claim 18, wherein the promotional product is a pet toy, and wherein a functionality of the one or more functionalities involves moving the pet toy erratically across a surface.

35) The claim as recited in claim 34, wherein the functionality involves moving a weighted element from a first position on the inside of the device housing to a second position on the inside of the device housing.

36) The claim as recited in claim 18, wherein one activation module of the one or more activation modules includes at least three tilt switches and wherein any two tilt switches of the at least three tilt switches must be in a closed position in order to activate the activation module.

37) The claim as recited in claim 18, wherein the promotional product is a pet toy, and wherein the device housing includes a central area and a plurality of arms extending from the central area, wherein the activation module comprises a tilt switch positioned in at least two of the arms, and wherein activation requires exactly two of the tilt switches to be closed at any one time.

38) A circuit for implementing a false activation reducing centrifugal activation system in a device, comprising:
a power supply module capable of powering an electrical load of the device;
an electrical load separated from the power supply module by two or more opposing tilt switches connected in series; and
a time module for storing an electrical charge and controlling the supply of power to the electrical load for a predetermined period of time.

39) The claim as recited in claim 38, wherein the load is a light producing module.

40) The claim as recited in claim 39, wherein the light producing module is a plurality of LEDs.

41) The claim as recited in claim 40, wherein the plurality of LEDs are arranged into a plurality of branches of dual series connected LEDs.

42) The claim as recited in claim 41, wherein each of the plurality of branches of dual series LEDs include a resistor in series to limit current to the LEDs.

43) The claim as recited in claim 38, wherein the load is a sound producing module.

44) The claim as recited in claim 38, wherein the load is a movement producing module.

45) The claim as recited in claim 38, wherein the load is a heat producing module.

46) The claim as recited in claim 38, wherein the load is a microcontroller.
